(19) United States
(12) Patent Application Publication
(10) Pub. No.: US 2016/0158938 A1
(43) Pub. Date: Jun. 9, 2016

(54) METHOD AND DEVICE FOR DEFINING A WORKING RANGE OF A ROBOT

(71) Applicant: gomtec GmbH, Seefeld (DE)

(72) Inventor: Bernd Gombert, Worthsee (DE)

(21) Appl. No.: 14/907,803

(22) PCT Filed: Jul. 22, 2014
(86) PCT No.: PCT/EP2014/065709

§ 371 Date: Jan. 26, 2016

(30) Foreign Application Priority Data
Jul. 30, 2013 (DE) 102013108115.0

(51) Int. Cl. B25J 9/16

(52) U.S. Cl. CPC B25J 9/1676; B25J 9/1697; Y10S 901/30; Y10S 901/47

(57) ABSTRACT

The invention relates to a method for defining a working range (A, A′) in which a robot (3) can guide a tool (7) fastened to the robot. According to the invention, the working range (A, A′) is defined in that a viewing body (K, K′), within which an image-capturing unit (6) captures images, is defined by positioning and/or setting the focal length of the image-capturing unit (6) and the working range (A, A′) is defined in dependence on the lateral boundary (11, 11′).

The invention relates to a method for defining a working range in which a robot can guide a tool according to the preamble of claim 1, as well as a robot system according to the preamble of claim 11.

Known robot systems which are referred to below comprise an input device, such as, for example, a joystick or an image-capturing system, which is operated manually by a user in order to move a robot or execute certain actions. The control demand by the user are converted here into corresponding control commands by the input device, which are executed by one or more robots. Known input devices usually have several sensors which detect the control demands of the user and convert them into corresponding control signals. The control signals are then further processed in open-loop or closed-loop controls which finally generate positioning signals with which the actuators of the robot or of a tool mounted on the robot are controlled, such that the robot or the tool executes the actions desired by the user.

In the case of surgical robot applications, a specific working range is usually defined, within which the surgeon can move and operate the surgical instrument. If the surgeon attempts to move the surgical instrument out of the predetermined working range, this is automatically recognized by the surgery robot and prevented. The surgeon can therefore only treat the organs or tissue lying within the working range. It should therefore be prevented that organs or tissue outside the actual operating region are accidentally damaged during a surgical intervention.

EP 2 384 714 Al describes, for example, a method for defining a working range for a surgery robot system. According to this, the surgeon can lay a virtual intersecting plane through the tissue to be operated which is depicted three-dimensionally. The intersecting surface of the virtual intersecting plane with the tissue thereby defines the working range.

The object of the present invention is to propose an alternative method as well as an alternative device for defining a working range.

This object is solved according to the invention by the features specified in claim 1 as well as in claim 11. Further embodiments of the invention result from the sub-claims.

According to the invention, a method for defining a working range in which a robot can guide a tool fastened thereto, with the aid of an image-capturing device, is proposed. Here, a viewing body of the image-capturing device is initially defined by positioning and/or setting the focal length of the image-capturing device. The viewing body thereby defines the space within which the image-capturing device can capture images. In other words, the viewing body is determined by the bundle of all (reflected) light rays which can be captured by the image-capturing device. Then, geometric data with regard to the lateral boundary of the viewing body are determined and finally the working range is defined in a spatial region which is dependent on the lateral boundary of the viewing body. In order to define a certain working range, a user, such as, for example, a surgeon, must therefore only position the image-capturing device in the desired manner and/or set a desired focal length and preferably confirm the setting. A control unit of the robot system then automatically determines a working range depending on the position and/or focal length of the image processing device. If the image captured by the image-capturing device is shown completely on a monitor, the entire allowed working range can be monitored on the monitor.

If the user controls the robot system in such a way that the tool or the end effector thereof reaches the boundary of the working range, the movement is preferably automatically stopped. This interruption can fundamentally occur on the boundary or at a predetermined distance to the boundary. The position of the tool or of the end effector can, for example, be recognized by the image-capturing device or another suitable sensor system.

The image-capturing device referred to above preferably comprises a camera and can, for example, be formed as an endoscope.

The viewing body is, as explained, determined by all light rays which can be captured by the image-capturing device. Objects which are located outside the geometric viewing body can therefore not be captured by the image-capturing device. In principle, the geometric viewing body can have a wide variety of shapes which depend on the respectively used lens of the image-capturing device. As, as a rule, round lenses are used, the viewing body usually has the shape of a cone.

In the scope of this document, a “robot” is in particular understood to be any machine having one or more jointed arms which are movable by means of one or more actuators, such as, for example, electric motors.

According to the invention, the working range is preferably defined in a spatial region which lies at least partially, preferably completely within the lateral boundary of the viewing body.

According to a first embodiment of the invention, the working range can be defined, for example, in such a way that the lateral boundary thereof corresponds to the lateral boundary of the viewing body. In this case, the working range therefore corresponds to the volume of the viewing body. If the viewing body, for example, is conical, the working range is limited by a cone surface. The freedom of lateral movement of the robot or tool thereby depends on the depth (i.e. the distance from the lens) in which the robot or the tool is guided. The greater the depth, the greater the cone cross-section and therefore the freedom of lateral movement.

According to a second embodiment of the invention, the working range is defined in a spatial region which lies within the viewing body and is smaller than the volume of the viewing body. In the case of a conical viewing body, the working range can, for example, be a pyramid which is arranged within the viewing body.

The working range preferably has a rectangular cross-section. Therefore, it is possible to adapt the working range to the format of a rectangular screen on which the image captured by the image-capturing device is displayed. The working range is preferably defined in such a way that the lateral limiting of the screen simultaneously also represents the limiting of the working range. A surgeon can therefore monitor the entire working range on the screen.

In order to adapt the working range to a rectangular screen, for example, a diagonal of the rectangular cross-section can be set at a certain depth of the working range such that it corresponds to the diameter of the conical viewing body at this position. The boundary of the image displayed on a monitor then corresponds to the boundary of the working range.

According to another embodiment of the invention, the working range could also be defined depending on an intersecting line or intersecting surface of the viewing body with a virtual plane. Therefore, different working volumes can be defined by any cone intersections. The intersecting plane can be displayed to the user on a screen. Below, a simple example: the intersection of a conical viewing body (more exactly the lateral surface thereof) with a virtual plane, the surface normal of which, for example, is directed in the longitudinal direction of the viewing cone, results in a circular intersecting line. The working range of the robot can now, for example, be limited to a cylinder, the periphery of which corresponds to the circular intersecting line. In order to define the working range, the user can either adjust the image-capturing device, as was described previously—the virtual intersecting plane thus remains fixed in position—or he could also adjust the virtual intersecting plane. Alternatively, for example, a cuboidal working range having a rectangular cross-section could also be generated, the corners of which, for example, lie exactly on the circular intersecting line. The size of the cross-section is in turn dependent on the intersection of the viewing cone with the virtual plane.

The working range can, for example, be conical, pyramidal, cylindrical or cuboidal, or can have another geometric shape.

The shape of the working range is preferably able to be selected by the user.

According to a preferred embodiment of the invention, the viewing body and/or the selected working range is preferably superimposed onto the image which is captured by the image-capturing device and displayed on a monitor. The user then sees the captured image and, for example, (colored) lines, which specify the viewing body or working range.

The working range can in principle be unlimited in depth, but it can also be limited in depth by specification of at least one boundary surface. This can, for example, occur automatically without a user input being required for this. Optionally, the depth of the working range could, however, also be predetermined by the user in that he, for example, inputs corresponding data. The input of data can, for example, occur by means of the control device, with which the robot is also controlled.

According to a specific embodiment of the invention, the working range is limited to a spatial region between two surfaces which are arranged at a varying distance to the optics. The surfaces can fundamentally be any free form surfaces. However, the limiting surfaces are preferably planes. In order to set a depth limit, the user can, for example, mark one or more points in the image depicted on the screen, through which the boundary surface(s) is/are to run. The system recognizes such an input as a specification of one or more boundary surfaces and restricts the working range accordingly.

A new alignment or setting of the image-capturing device initially preferably does not change the active working range. In order to change the working range, the surgeon must preferably carry out a corresponding input, such as, for example, the operation of a button. Alternatively, however, it could also be provided that the working range is automatically adapted if the position and/or the focal length of the image-capturing device is adjusted.

Optionally, for example, different working ranges which were previously defined can be stored. The robot system could, in this case, be designed such that the surgeon can change between the different stored working ranges on request, for example by pressing a button, without having to change the position and/or focal length of the image-capturing device for this purpose.

The invention also relates to a robot system having at least one first robot, on which an image-capturing device is mounted, which can capture images within the limits of a viewing body, and having a second robot to which a tool, in particular a surgical instrument, is fastened.

The robot system furthermore comprises an input device, by means of which one or both robots are controlled. According to the invention, a control unit is furthermore provided which determines geometric data with regard to the boundary of the viewing body and defines a working range depending on the boundary of the viewing body, within which working range a robot can be moved or a robot can guide a tool fastened thereto.

In the scope of this document, a “robot system” is in particular understood to be a technical system having one or more robots which can furthermore comprise one or more tools operated by robots and/or one or more further machines. A robot system which is equipped for use in minimally invasive surgery can, for example, comprise one or more robots which are each equipped with a surgical instrument or another tool, as well as an electrically adjustable operating table.

Suitable input devices to control the robot system can, for example, be: joysticks, mice, keyboards, control panels, touch panels, touch screens, consoles and/or camera-based image processing systems as well as all other known input devices which can capture the control specifications of a user and can generate corresponding control signals.

The robot system according to the invention preferably also comprises means to provide a depth limit of the working range, as has been described above. The means referred to are preferably part of the input to control the robot(s).

The image-capturing device preferably comprises an image sensor which converts the optical signals into electrical signals. The image sensor can, for example, be round or rectangular.

### BRIEF DESCRIPTION OF THE DRAWINGS

The invention is explained in more detail below by way of example by means of the enclosed drawings. Here are shown:

FIG. 1 a schematic depiction of a robot system 1 for minimally invasive surgery;

FIG. 2 a schematic depiction of a viewing body of an image-capturing device with different focal lengths;

FIG. 3 a schematic depiction of a viewing body of an image-capturing device with different distal positions of the image-capturing device;

FIG. 4 the optical illustration of an object in an image;

FIG. 5 a schematic depiction of a working range which is limited both in the lateral direction and in depth;

FIG. 6 a method to adapt the working range to the format of a screen; and

FIG. 7 a modified working range which is adapted to the format of a screen.

### EMBODIMENTS OF THE INVENTION

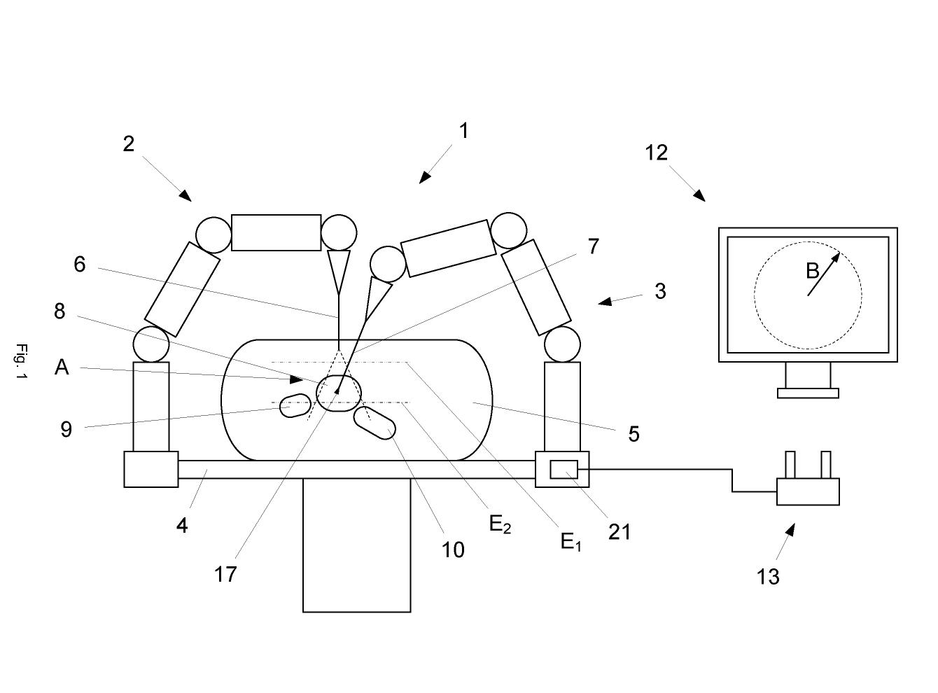

FIG. 1 shows a robot system 1 for minimally invasive surgery, which comprises a first robot 2 which is equipped with an image-capturing device 6, such as, for example, an endoscope, as well as a second robot 3, to which a surgical instrument 7 is fastened. For example, the instrument 7 can comprise a scalpel in order to remove a tumor on the organ 8. The robots 2, 3 are formed here as multiunit robot arms, wherein each arm unit is connected to another arm unit movably via a joint.

The robot system 1 furthermore comprises an OP table 4 on which a patient 5 lies on whom a surgical intervention is carried out. The two robots 2, 3 are each fastened laterally on the OP table 4 and positioned such that the image-capturing device 6 and the surgical instrument 7 are introduced into the body of the patient 5 through small artificial incisions. The camera integrated into the endoscope 6 captures the operation. The image B captured by the camera is displayed on a screen 12. The surgeon can therefore—provided the endoscope 6 is correctly set—observe and monitor the progress of the operation on the screen 12. The image-capturing device 6 and the screen 12 are preferably 3D-capable in order to be able to generate a plastic image.

An input device 13 is provided to control the robots 2, 3 and/or the tools 6, 7 fastened thereto, which is operated manually by the surgeon. In the depicted exemplary embodiment, the input device 13 comprises an operating console having two joysticks. Alternatively, however, any other input device could also be provided, such as, for example, an image processing system with which the robots 2, 3 can be controlled by means of gesture control. The control commands executed by the surgeon are converted into corresponding electrical signals by the input device 13 and are processed by a control unit 21. The control unit 21 generates corresponding positioning signals with which the individual actuators of the robots 2, 3 and/or the tools 6, 7 are controlled, such that the robot system 1 executes the actions desired by the surgeon.

A robot-supported surgical intervention is a relatively sensitive operation in which it must be ensured that organs or tissue which lie or lies around a certain operation region are not harmed. In the depicted example, an organ 8 is to be treated; the organs 9 and 10, however, shall not to be treated. In order to prevent the organs 9, 10 from being accidentally harmed, the surgeon can define a working range A which is indicated here by dashed lines. After the working range A has been defined, the surgeon can only move or operate the instrument 7 or the end effector 17 thereof within the working range A. If the surgeon accidentally controls the instrument 7 or the end effector 17 thereof outside the boundaries of the working range A, this is recognized and prevented by the robot system 1. An accidental harm of surrounding organs 9, 10 is therefore prevented.

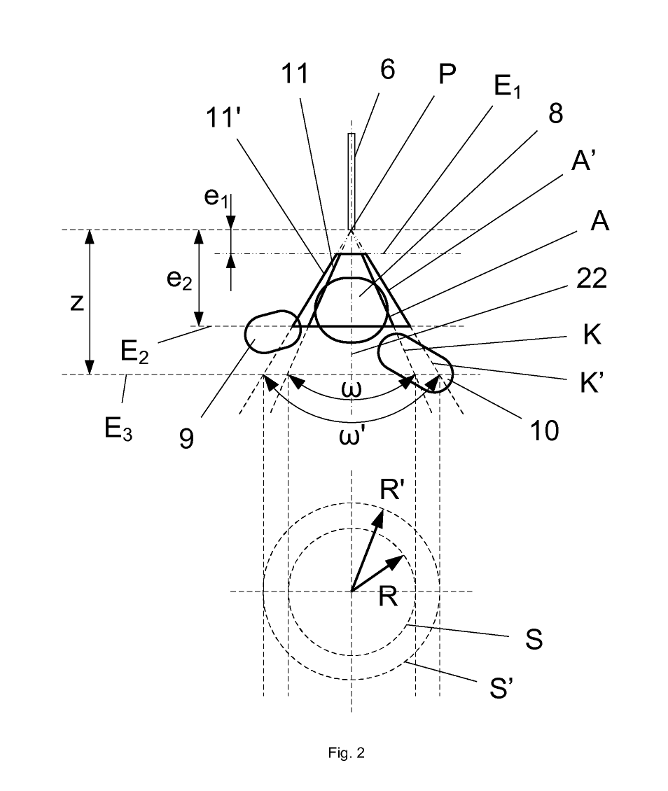

FIG. 2 shows an enlarged view of the operation region in the body of the patient 5 of FIG. 1. Additionally, in FIG. 2, various viewing bodies K, K′ are depicted with different focal lengths of the lens of the image-capturing device 6. The geometric viewing body K, K′ is determined here by all light rays which can be captured by the image-capturing device 6. Objects which are located outside the viewing body K or K′ are therefore not able to be captured by the image-capturing device 6. The outer lateral boundary of the respective viewing body K, K′ is a lateral surface which is referred to with the reference numeral 11, 11′. In the depicted example, the lens of the image-capturing device 6 comprises a round image sensor; the lateral surface of the viewing body K, K′ is therefore conical.

In this exemplary embodiment, the lens of the image-capturing device 6 enables a zooming in and out to or from the captured object. The zoom function can, for example, also be controlled by means of the input device 13. A first zoom setting is depicted by a viewing body K with an opening angle ω, by way of example. If the surgeon zooms in to the patient, i.e. he enlarges the focal length, then the angle ω of the viewing body K becomes smaller. If, on the other hand, he zooms out from the patient 5, i.e. he decreases the focal length, then the angle ω becomes larger. A second zoom setting with a smaller focal length is depicted by a viewing body K′ having the opening angle ω′, by way of example. Correspondingly, with regard to a freely selected projecting reference plane E₃ for mutual comparison, in the first case, a smaller field of vision S having a smaller radius R results and, in the second case, a larger field of vision S′ having a larger radius R′ results. These two fields of vision are in principle theoretically possible. In practice, however, the field of vision S can be limited laterally, in particular then if the lateral surface 11 of the viewing body K, K′ intersects an organ. As is evident from FIG. 2, the lateral surface 11 intersects the organ 8 and lateral surface 11′ intersects the organs 9 and 10. Correspondingly, the actual regions of vision S or S′ result. In other words, the field of vision S, S′ is also measured according to how deeply the instrument 6 can see into the patient. As the viewing body K′ is not limited laterally by organ 8, organ 8 can be seen past and therefore the patient 5 can be inspected more deeply, whereby a larger field of vision S′ results in comparison to the viewing body K with the field of vision S.

The geometric viewing body K or K′ can in principle have different shapes. Due to the round lenses usually used, however, it typically has the form of a cone, as is depicted here.

In order to now select a certain working range A, A′, the surgeon can change the focal length of the image-capturing device 6 and therefore select a larger or smaller field of vision S. The shape of the generated viewing body K, K′ thereby determines the shape of the permissible working range A or A′. After the surgeon has carried out the desired setting, he must confirm the setting by an input. For this purpose he can, for example, operate a button of the input device 13, pronounce a voice command or, for example, execute an input in a software application using a mouse. After the input has occurred, the robot system 1 automatically defines the lateral boundary of the working range A, A′ according to the setting of the viewing body K or K′ which has been carried out. In the case of the viewing body K, the working range A, for example, can automatically be defined in a spatial region which is located within the boundary 11 of the viewing body K. According to a specific embodiment of the invention, the lateral boundary of the working range A corresponds to the lateral boundary 11 of the viewing body K. The same applies for the viewing body K′. Therefore, the lateral boundary is determined by the lateral surface of the viewing body K or K′. Alternatively, the working range A, A′ could, however, also have another shape, which is functionally dependent on the shape of the viewing body K, K′.

As can be recognized in FIG. 2, the working range A, A′ is additionally limited in depth, i.e. in a z-axis running in the direction of a central ray 22 of the viewing body K. In the depicted exemplary embodiment, the working range A, A′ is limited at an upper or lower end, in each case by a cross-sectional plane E₁ or E₂. Optionally, the working range A or A′ could, however, also be limited by any three-dimensional free form surfaces.

In order to set the depth and/or height restriction of the working range A or A′, the surgeon can, for example, input corresponding distance values e₁ and/or e₂. The distance values e₁, e₂ can, for example, refer to a reference point P, here the distal end of the image-capturing device 6. Therefore, with the plane E₁, a height limit can be defined, above which an operation cannot be carried out with the instrument 7 or end effector 17, and with plane E₂, a depth limit can be defined, beneath which an instrumental intervention is prevented.

Alternatively, the surgeon could also click on certain positions on the image displayed on the screen 12 in order to provide the position of the depth or height limit. Additionally, many further possibilities exist to set a depth or height limit which the person skilled in the art can implement without a problem.

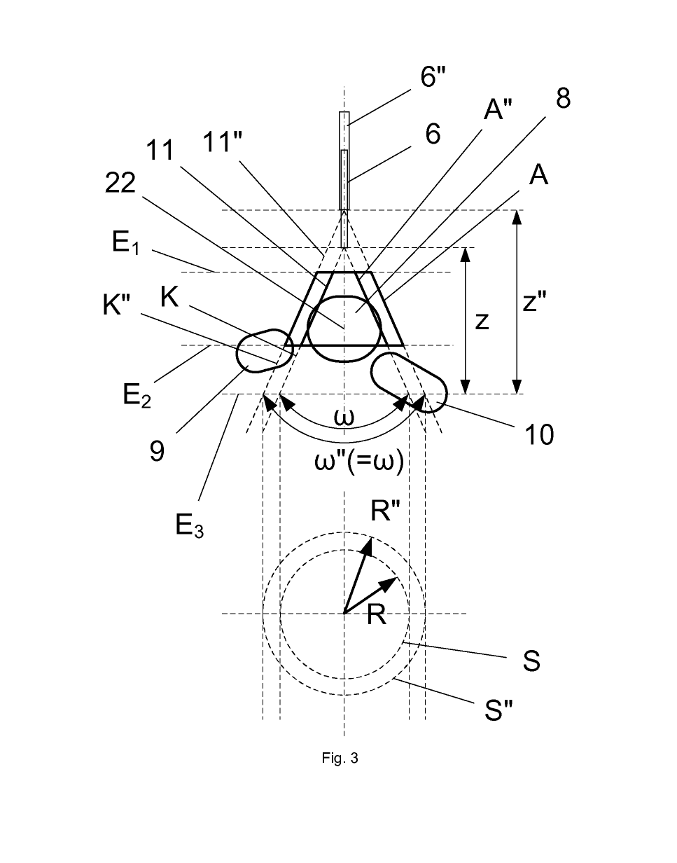

After the setting of the desired working range A, A′ has occurred, the surgeon can begin the operation. If he would like to change the working range A, A′ in the course of the operation, he can do this by, for example, adjusting the focal length of the lens and/or adjusting the boundary surfaces E₁, E₂. He could, however, also change the position of the image-capturing device 6, as will be explained in detail below by means of FIG. 3. The size of the working range A, A′ can in principle be automatically adapted after each change; an input, however, can also be required in order to confirm the change by the surgeon.

FIG. 3 shows a further method to set a working range A, A″ which can be used alternatively or in addition to the method from FIG. 2. In FIG. 3, the same operation region is depicted in the body of the patient 5 as in FIG. 2. The image-capturing device 6 in turn captures images within a viewing body K or K″. The position of the viewing body K, K″ is changed in this case by adjusting the image-capturing device in the z direction. If the image-capturing device 6 is pushed deeper into the patient, the associated viewing body K shifts further downwards. If the image-capturing device 6, however, is pulled out of the patient (depicted by reference numeral 6″), the associated viewing body K″ shifts further upwards. The opening angle ω or ω′ thus remains the same.

The surgeon can therefore change the location of the working range A, A″ by leading the image-capturing device 6 towards or moving it away from the organ 8 to be treated. In the depicted example, the working range A comprises the organ 8 and a part of the organ 10. The organ 9, however, lies outside the working range A. The working range A″, however, also comprises a part of the organ 9 such that this organ could also be treated.

From the examples shown in FIGS. 2 and 3, it becomes clear that the surgeon can define a working range A, A′, A″ by setting the focal length and/or position of the image-capturing device as required. The working range A or at least a part thereof is displayed to the surgeon, preferably on the screen 12.

A new alignment or setting of the image-capturing device 6 initially preferably does not change the active working range A. In order to change the working range A, the surgeon must preferably carry out a corresponding input, such as, for example, the operation of a button. Alternatively, however, it is also provided that the working range A is automatically adapted if the position and/or the focal length of the image-capturing device 6 is adjusted.

Optionally, for example, different working ranges A, A′, A″ which were previously defined can also be stored. The robot system 1 could, in this case, be designed such that the surgeon can change between the different stored working ranges A, A′, A″ on request, such as for example by pressing a button, without having to change the position and/or the focal length of the image-capturing device 6 for this purpose.

In order to select a specific working range A, A′, A″, the surgeon can both change the position of the image-capturing device 6 and the focal length of the image-capturing device 6. For example, in a first step, the surgeon could initially position the image-capturing device 6 and subsequently set the focal length. The robot system 1 according to the invention can additionally also comprise a control device which checks whether the working range A describes a closed volume, i.e. it is checked whether at least one of the surfaces E₁ or E₂ has been defined which limits the viewing body K in terms of its depth. As long as no closed volumes have been defined, the surgeon preferably cannot control the robots 3. The error state is preferably indicated to the user, for example by an optical or acoustic display.

What is included by the viewing cone K, K′, K″ is captured directly by the image-capturing device 6 and displayed to the surgeon on the monitor 12 as an image B. Therefore, the surgeon has the opportunity to adapt the viewing cone or the working range according to his needs. After the surgeon has positioned the image-capturing device 6, for example, an angle ω′ can initially be originated from. As shown in FIG. 2, organs 9 and 10 also project into the associated viewing cone /K′ which are to be protected from accidental surgical intervention. If the surgeon were to now define the viewing cone K′ as a valid working range A, the risk would therefore exist that the organs 9 or 10 could be damaged, for example if the surgeon controls the instrument 7 laterally past organ 8.

Therefore, the surgeon can further restrict the working range by additionally zooming in to the body of the patient with the image-capturing device 6. For example, the angle ω′ of the viewing cone K′ can thereby be reduced to an angle α such that the organ 9 is completely excluded from the associated viewing cone K. Furthermore, the viewing cone K can be restricted with regard to the organ 10 in such a way that the organ 10 is covered by organ 8. In other words, the surgeon can no longer damage organ 10 by controlling the instrument 7 accidentally past organ 8.

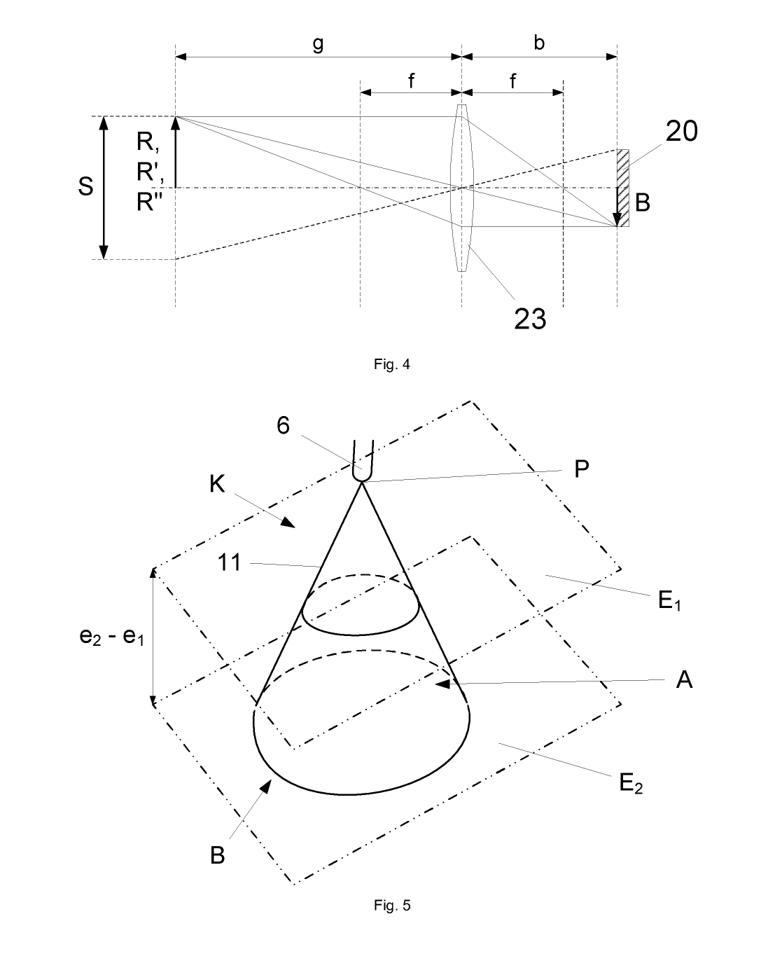

In this context, FIG. 4 schematically clarifies the illustration of an object by means of a lens 23 in an image B. Here:

$$\frac{B}{R} = \frac{b}{g} \qquad ( 1 )$$

applies, with the image width b and the object width g.

R refers here to a radius of the viewing field S at a distance g from the lens 23. Furthermore:

$$\frac{1}{f} = \frac{1}{b} + \frac{1}{g} \qquad ( 2 )$$

applies, wherein f is the focal length.

The image B is distinguished by an image sensor 20 which converts the optical signals into corresponding electrical signals. The image sensor 20 can, for example, be formed to be round in order to be able to capture the viewing field S of the viewing body K completely. Optionally, however, a rectangular image sensor 20 could also be used, as is typically used in conventional cameras. The image B captured by the image sensor 20 is finally depicted to the surgeon on a screen 12.

FIG. 5 shows a perspective depiction of a conical viewing body K having an associated working range A. The working range A is limited in the lateral direction by the lateral surface 11 of the viewing cone K. The depth and height of the working range

A is limited by two planes E₁ and E₂. Overall, a closed working range A therefore results in the shape of a truncated cone. Here, E₁ preferably defines a surface above which an operation of the instrument 7 or of the end effector 17 is not allowed and E₂ defines a surface below which an operation of the instrument 7 or of the end effector 17 is not allowed. According to the invention, however, it is not necessarily required to define both planes. It is also possible to only define one of the two planes E₁ or E₂.

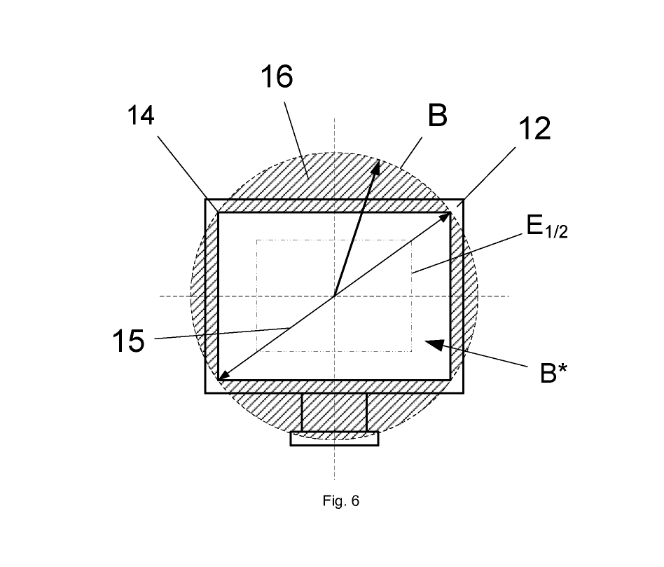

FIG. 6 shows a depiction of a screen 12 and of an image B displayed thereon, to explain the adaptation of the working range A to the format of the screen 12. As is shown, the round image B is fitted into the rectangular depiction region of the screen 12 such that the screen surface of the screen 12 is used completely to display the image B. The screen diagonal 15 corresponds, in this case, to the diameter of the image B. The depiction region of the screen 12 can thereby be used completely; a part 16 of the image B lying outside the depiction region can, however, in this case not be displayed.

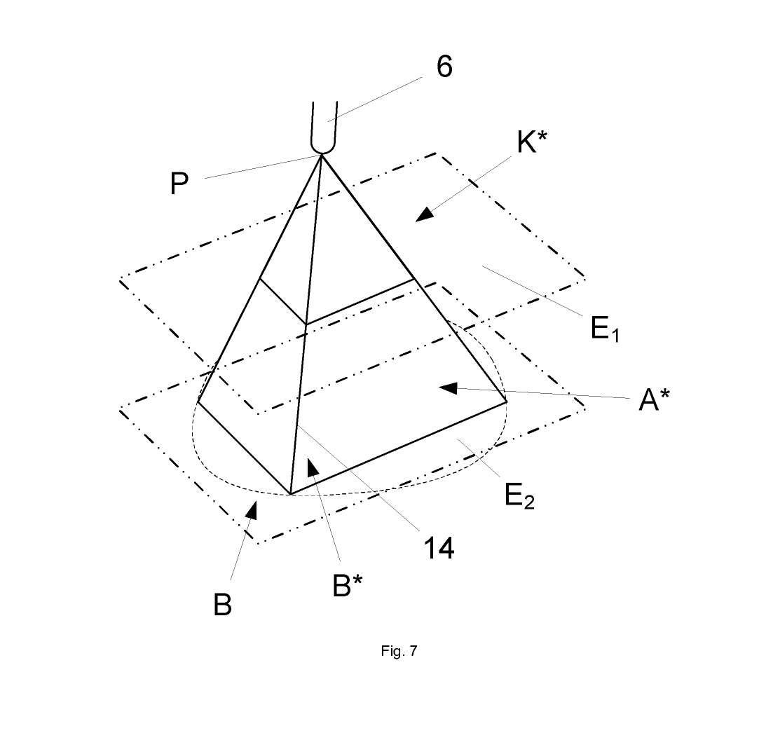

If the working range A were conical, such as, for example, is depicted in FIG. 5, the surgeon could no longer completely monitor the working range A. According to a specific embodiment of the invention, the working range A is therefore adapted to the format of the screen. For this purpose, the working range A corresponding to the viewing body K is reduced by the regions 16 not able to be depicted on the screen 12. Therefore, a pyramidal working range A* results from the conical working range A, as is depicted by way of example in FIG. 7. The pyramidal working range A* is therefore dimensioned such that a vertically running outer edge 14 of the working range A* lies on the lateral surface 11 of the conical viewing body K. Furthermore, the diameter of the image B preferably corresponds to the screen diagonal 15.

The adaptation of the working range A to the format of the screen 12 can occur automatically if the image format of the screen 12 is known. For a full HD monitor, for example, a format of 1920×1080 pixels can be automatically recognized. The use of a modified working range A* has the advantage that the surgeon, on the one hand, sees the entire available working range in which he can operate, and that on the other hand there are no regions in which he could operate which, however, he cannot monitor on the screen 12. As can be recognized in FIG. 7, the modified working range A* can also be limited in depth and height extension by one or more surfaces E₁, E₂.

1. A method for defining a working range in which a robot can guide a tool fastened thereto or the end effector thereof, comprising the following steps:
defining a viewing body, within which an image-capturing device can capture images, by positioning the image-capturing device and/or by setting the focal width of the image-capturing device;
determining geometric data with regard to the boundary of the viewing body; and
defining a working range depending on the boundary of the viewing body.

2. The method according to claim 1, wherein the working range is defined in a spatial region which lies at least partially within the boundary of the viewing body of the image-capturing device.

3. The method according to claim 1, wherein the working range is defined in such a way that the lateral boundary thereof corresponds to the lateral boundary of the viewing body.

4. The method according to claim 1, wherein the working range is defined in a spatial region with a rectangular cross-section which lies within the lateral boundary of the viewing body and has the format of a screen on which an image captured by the image-capturing device is displayed.

5. The method according to claim 4, wherein a diagonal of the rectangular cross-section at a certain position corresponds to the diameter of the viewing body at this position.

6. The method according to claim 1, wherein the working range is conical, pyramidal, cylindrical or cuboidal.

7. The method according to claim 1, wherein the working range is limited in depth.

8. The method according to claim 7, wherein the working range is limited in depth depending on a user specification.

9. The method according to claim 7, wherein the working range is limited in depth in a spatial region which is arranged between two surfaces.

10. The method according to claim 9, wherein the surfaces are planes.

11. A robot system having at least one first robot on which an image-capturing device is mounted which can capture images within the boundaries of a viewing body, and a second robot to which a tool, in particular a surgical instrument, is fastened, wherein the robot system comprises an input device, by means of which one or both robots are able to be controlled, wherein a control unit is provided which determines geometric data with regard to the boundary of the viewing body and defines a working range which is dependent on the lateral of the viewing body of the image-capturing device.

12. The robot system according to claim 11, wherein the control unit defines a working range which lies at least partially within the boundaries of the viewing body of the image-capturing device.

13. The robot system according to claim 11, wherein a device to provide a depth limitation of the working range is provided.
